(19) United States
(12) Patent Application Publication
(10) Pub. No.: US 2018/0236598 A1
(43) Pub. Date: Aug. 23, 2018

(54) METHOD FOR REPAIRING DISPLAY DEFECT

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Jingang HAO, Beijing (CN); Jianxing SHANG, Beijing (CN); Huibo ZHANG, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/551,617

(22) PCT Filed: Feb. 17, 2017
(86) PCT No.: PCT/CN17/73886

§ 371 Date: Aug. 17, 2017

(30) Foreign Application Priority Data
Jun. 1, 2016 (CN) 201610382226.1

(51) Int. Cl. B23K 26/00; B23P 6/00

(52) U.S. Cl. CPC B23K 26/0066; B23K 2201/36; B23P 6/00

(57) ABSTRACT

A method for repairing a display defect includes: detecting the display defect in a display panel; and repairing a partial structure of the display defect so that a size of a remaining structure of the display defect is smaller than a test standard value.

### CROSS REFERENCE

The present application is based on International Application No. PCT/CN2017/073886, filed on Feb. 17, 2017, which is based upon and claims priority of Chinese Patent Application No. 201610382226.1 titled “method for repairing display defect” and filed on Jun. 1, 2016, and the entire contents thereof are incorporated herein by reference.

### TECHNICAL FIELD

The present disclosure relates to the field of display technology, and more particularly to a method for repairing a display defect.

### BACKGROUND

In the field of display technology, for dot defects, there are two kinds of defects, one is a pixel defect, and the other is a foreign matter defect in a cell. Wherein, the pixel defect is that the entire pixel is bright or dark. That is, pixel defects include bright spots or dark spots. It is required that both the number of the bright spots and the number of the dark spots are small. The foreign matter defect is usually a dead spot with irregular shape. The dead spot will not occupy the entire pixel. It is required that diameter of the foreign matter defect is small. The difference between the above described pixel defect and the foreign matter defect is whether the bright spot occupies the entire pixel.

For the pixel defect and the foreign matter defect, there is no method in the related art that can repair the defect so that customers can be satisfied.

It should be noted that, information disclosed in the above background portion is provided only for better understanding of the background of the present disclosure, and thus it may contain information that does not form the prior art known by those ordinary skilled in the art.

### SUMMARY

The present disclosure provides a method for repairing a display defect.

The present disclosure provides a method for repairing a display defect, comprising: detecting the display defect in a display panel; and repairing a partial structure of the display defect so that a size of a remaining structure of the display defect is smaller than a test standard value.

In one embodiment, the detecting the display defect in a display panel comprises detecting that the display defect in the display panel is a pixel defect; and the repairing a partial structure of the display defect comprises repairing a partial structure of the pixel defect so that a size of a remaining structure of the pixel defect is smaller than the test standard value.

In one embodiment, the pixel defect is a bright spot; and the repairing a partial structure of the pixel defect comprises repairing a partial structure of the pixel defect to obtain a partial dark spot, and the remaining structure of the pixel defect is a partial bright spot.

In one embodiment, the partial dark spot comprises a ring structure, an inverted L-shaped structure, one or more rectangular structures, or one or more circular structures.

In one embodiment, an area of the remaining structure of the pixel defect is within ⅙ to ½ of a total area of the pixel defect.

In one embodiment, an area of the remaining structure of the pixel defect is within ⅕ to ⅓ of a total area of the pixel defect.

In one embodiment, the detecting the display defect in a display panel comprises detecting that the display defect in the display panel is a foreign matter defect; and the repairing a partial structure of the display defect comprises repairing a partial structure of the foreign matter defect so that a size of a remaining structure of the foreign matter defect is smaller than the test standard value.

In one embodiment, a diameter of the remaining structure of the foreign matter defect is smaller than the test standard value.

In one embodiment, the repairing a partial structure of the display defect comprises repairing a partial structure of the pixel defect by a laser repairing.

### BRIEF DESCRIPTION OF THE DRAWINGS

FIG. 1 is a diagram showing a bright spot in the related art;

FIG. 2 is a diagram showing a dark spot obtained by repairing the bright spot in FIG. 1;

FIG. 3 is a diagram showing a foreign matter defect in the related art;

FIG. 4 is a diagram showing the diameter of the foreign matter defect in FIG. 3;

FIG. 5 is a flow chart of a method for repairing a display defect provided by a first embodiment of the present disclosure;

FIG. 6 is a flow chart of a method for repairing a display defect provided by a second embodiment of the present disclosure;

FIG. 7 is a diagram showing a pixel defect in the second embodiment;

FIG. 8 is a diagram showing the remaining structure of a pixel defect in the second embodiment;

FIG. 9 is a diagram showing a shape of the remaining structure of a pixel defect in the second embodiment;

FIG. 10 is a diagram showing another shape of the remaining structure of a pixel defect in the second embodiment;

FIG. 11 is a diagram showing another shape of the remaining structure of a pixel defect in the second embodiment;

FIG. 12 is a diagram showing another shape of the remaining structure of a pixel defect in the second embodiment;

FIG. 13 is a diagram showing another shape of the remaining structure of a pixel defect in the second embodiment;

FIG. 14 is a diagram showing another shape of the remaining structure of a pixel defect in the second embodiment;

FIG. 15 is a flow chart of a method for repairing a display defect provided by a third embodiment of the present disclosure;

FIG. 16 is a diagram showing a foreign matter defect in the third embodiment; and

FIG. 17 is a diagram showing the remaining structure of a foreign matter defect in the third embodiment.

### DETAILED DESCRIPTION

In order to provide a better understanding of the technical solution of the present disclosure by those skilled in the art, the method for repairing a display defect provided by the present disclosure will be described in detail with reference to the accompanying drawings.

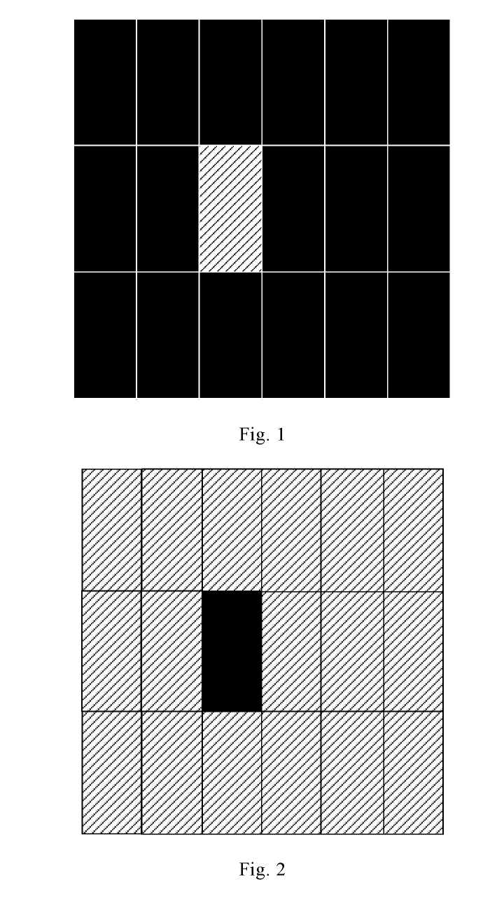

FIG. 1 is a diagram showing a bright spot in the related art. As shown in FIG. 1, the pixel in the third column and the second row of the image is green, and the rest pixels are black, that is, the pixel in the third column and the second row is a green bright spot. Similarly, it is possible that the pixel is a red bright spot or a blue bright spot. At present, the entire bright spot can be modified to a dart spot by a laser repairing (burning repairing). For example, the green bright spot shown in FIG. 1 can be repaired to be a dark spot. FIG. 2 is a diagram showing a dark spot obtained by repairing the bright spot in FIG. 1. As shown in FIG. 2, the pixel in the third column and the second row of the image is black, and the rest pixels are green, that is, the pixel in the third column and the second row is a dark spot obtained by repairing the entire bright spot in FIG. 1, the dark spot in the green image is shown in black. Some customers can tolerate that there are dark spots in a certain number of red images and blue images, but can not tolerate that there are dark spots in green images, and nor there are a certain number of green bright spots. Moreover, all customers have requirements for the number of the dark spots obtained by repairing the entire bright spot. Usually, customers can tolerate that the number of the dark spots is no more than two to five. Therefore, if there are too many bright spots and each bright spot is repaired to be a dark point, there will be risk that customers do not tolerate excessive number of dark spots. In summary, the repairing method in the related art can not completely satisfy the customer by only repairing the entire bright spot into a dark spot.

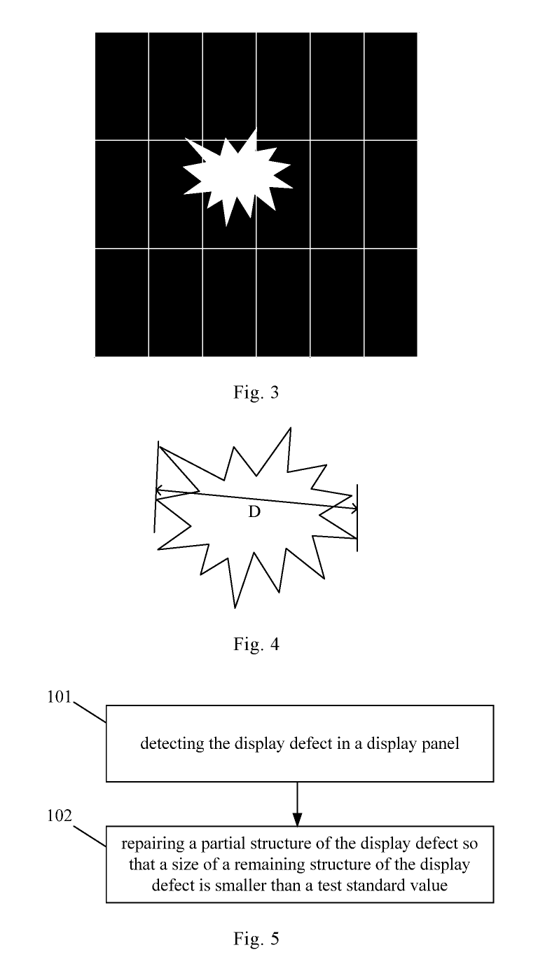

FIG. 3 is a diagram showing a foreign matter defect in the related art. FIG. 4 is a diagram showing the diameter of the foreign matter defect in FIG. 3. As shown in FIGS. 3 and 4, there is a foreign matter defect of the pixel in the lower part of the image. The foreign matter defect in FIG. 3 is white. As shown in FIG. 4, the diameter D of the foreign matter defect is large, and customers can not tolerate the foreign matter defect with the larger diameter D.

FIG. 5 is a flow chart of a method for repairing a display defect provided by a first embodiment of the present disclosure. As shown in FIG. 5, the method comprised the following steps.

At step 101, the display defect in a display panel is detected.

Specially, the display panel is detected so that the display defect in the display panel can be detected.

At step 102, a partial structure of the display defect is repaired, so that the size of the remaining structure of the display defect is smaller than a test standard value.

Specially, the partial structure of the display defect can be repaired by burning. Preferably, the size of the remaining structure may refer to the diameter of the remaining structure. That is to say, whether the remaining structure can be tolerated by the customers can be judged by the diameter of the remaining structure. In present embodiment, the diameter of the remaining structure of the repaired display defect is smaller than a test standard value. Therefore, the display defect can be tolerated by the customers after it is repaired.

According to the methods for repairing a display defect provided by the present disclosure, the display defect of the display panel is detected and a partial structure of the display defect is repaired so that the remaining structure of the display defect is smaller than a test standard value. Therefore, it can be realized that the display defect can be tolerated by the customers after it is repaired.

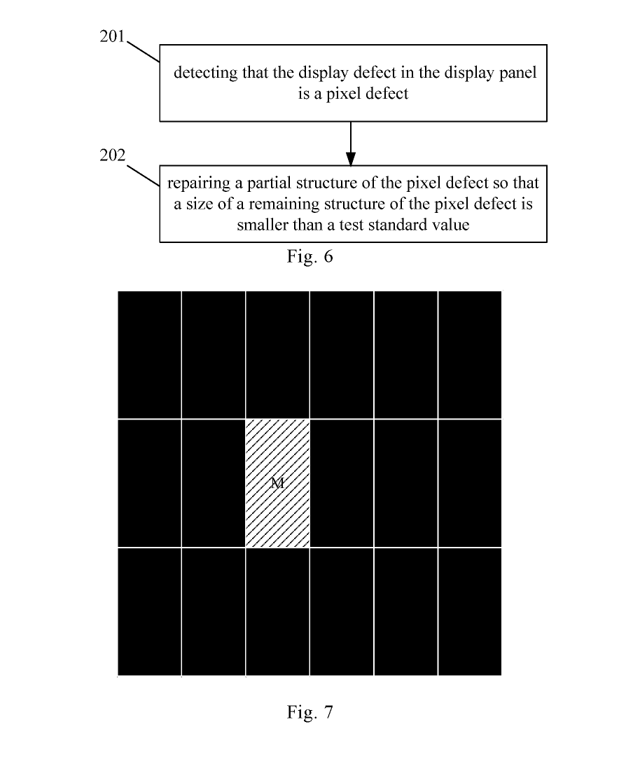

FIG. 6 is a flow chart of a method for repairing a display defect provided by a second embodiment of the present disclosure. As shown in FIG. 6, the method comprised the following steps.

At step 201, the display defect in a display panel is detected to be a pixel defect.

FIG. 7 is a diagram showing a pixel defect in the second embodiment. As shown in FIG. 7, the display panel comprises many pixels. By detecting the display panel, the display defect occurred in the pixel in the third column and the second row is a pixel defect M which is a bright spot. In the present embodiment, the bright spot is a green spot, that is, the entire pixel in the third column and the second row shows in green.

At step 202, the partial structure of the pixel defect is repaired, so that the size of the remaining structure of the pixel defect is smaller than a test standard value.

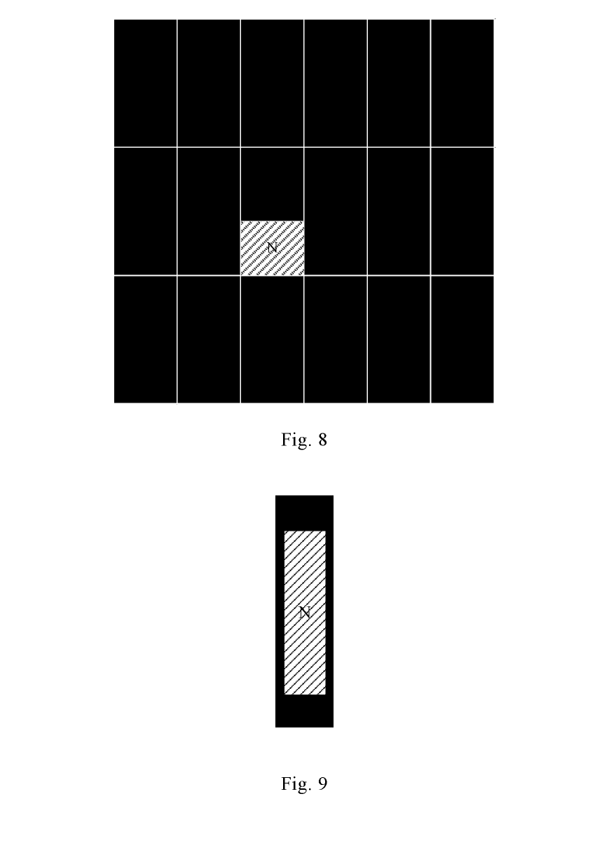

FIG. 8 is a diagram showing the remaining structure of a pixel defect in the second embodiment. As shown in FIG. 8, a partial structure of the pixel defect is repaired to be a dark spot, and the remaining structure N of the pixel defect is a partial bright spot. Specially, a partial structure of the pixel defect can be repaired by burning, so that the partial structure of the pixel defect can be repaired to be a partial dark spot. That is to say, in the present embodiment, the entire structure of the pixel defect is not repaired, but only the partial structure of the pixel defect is repaired. After repair, the diameter of the remaining structure N is less than the test standard value, so that the customers' requirements can be satisfied. The test standard value can be set according to the customers' requirements. For example: test standard value can be 0.1 mm to 0.5 mm. Wherein the diameter of the remaining structure N may be its diagonal length. When the partial structure of the pixel defect is repaired, the pixel defect is no longer occupy the entire pixel, then only part of the remaining structure is a partial bright spot, the partial bright spot is no longer a pixel defect but become a foreign matter defect. Thus, the size of the remaining structure can be judged by the judgment criteria of the foreign matter defect. If the size of the remaining structure is less than the test standard value, it indicates that the remaining structure as a foreign matter defect is acceptable to the customers.

As shown in FIGS. 7 and 8, the area of the remaining structure N of the pixel defect is within ⅙ to ½ of the total area of the pixel defect M. In one embodiment, the area of the remaining structure N of the pixel defect is within ⅙ to ⅓ of the total area of the pixel defect M. In one embodiment, the area of the remaining structure of the pixel defect is within ⅕ to ⅓ of a total area of the pixel defect. For example, in FIG. 8, the area of the remaining pixel N of the pixel defect is ⅓ of the total area of the pixel defect M. So that customers can better accept the repaired pixel defect.

In the present embodiment, the partial dark spot includes a ring structure, an inverted L-shaped structure, one or more rectangular structures, or one or more circular structures. The specific structure can be as shown in FIGS. 8 to 14.

As shown in FIG. 8, in the present embodiment, the partial dark spot is a rectangular structure, and the remaining structure N is a rectangular structure and is located at the lower portion of the pixel.

FIG. 9 is a diagram showing a shape of the remaining structure of a pixel defect in the second embodiment. As shown in FIG. 9, the partial dark spot is an annular structure, and the remaining structure N is a rectangular structure and located in the middle of the pixel. The partial dark spot surrounds the remaining structure N.

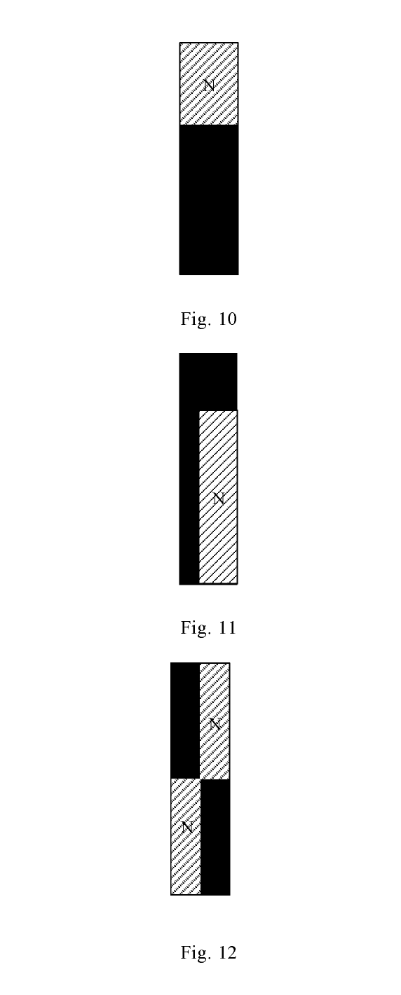

FIG. 10 is a diagram showing another shape of the remaining structure of a pixel defect in the second embodiment. As shown in FIG. 10, the partial dark spot is a rectangular structure, and the remaining structure N is a rectangular structure and located at the upper portion of the pixel.

FIG. 11 is a diagram showing another shape of the remaining structure of a pixel defect in the second embodiment. As shown in FIG. 11, the partial dark spot is an inverted L-shaped structure, and the remaining structure N is a rectangular structure. The partial dark spot is located in the upper left portion of the pixel, and the remaining structure N is located in the lower right portion of the pixel.

FIG. 12 is a diagram showing another shape of the remaining structure of a pixel defect in the second embodiment. As shown in FIG. 12, the partial dark dot includes two rectangular structures arranged opposite to each other. The remaining structure N comprises two diagonal structures arranged opposite to each other. The two rectangular structures in the partial dot are located at the upper left corner and lower right corner of the pixel, respectively, and two rectangle structures in the remaining structures N are located in the lower right corner and lower left corner of the pixel, respectively.

FIG. 13 is a diagram showing another shape of the remaining structure of a pixel defect in the second embodiment. As shown in FIG. 13, the partial dark dot comprises two rectangular structures and the remaining structure N comprises two rectangular structures. The rectangular structures in the partial dark spots and the rectangular structures in the remaining structure N are alternately arranged.

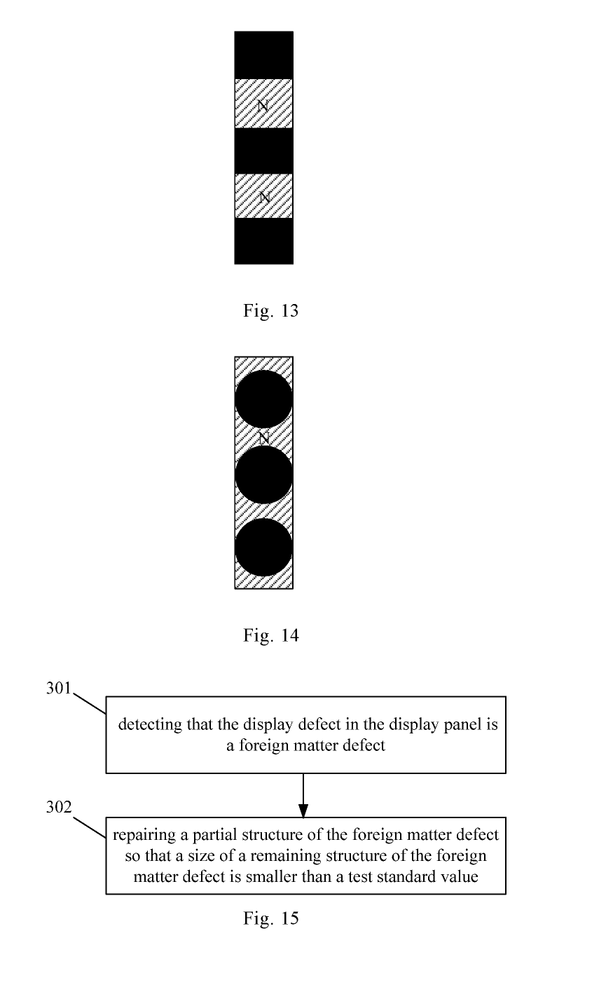

FIG. 14 is a diagram showing another shape of the remaining structure of a pixel defect in the second embodiment. As shown in FIG. 14, the partial dark spot comprises one or more circular structures, and the remaining structure N is a structure that surrounds the circular structures arranged in the pixel, wherein the number of circular structures is three.

In FIGS. 9 to 14, only one pixel with a pixel defect in the display panel is shown, and the remaining pixels are not specifically drawn. And the structures of the partial dark spots in FIGS. 8 to 14 are only a few examples. In practice, the partial dark spots may have other structures, and are not enumerated here.

According to the methods for repairing a display defect provided by the present disclosure, the display defect of the display panel is detected to be a pixel defect and a partial structure of the pixel defect is repaired so that the remaining structure of the pixel defect is smaller than a test standard value. Therefore, it can be realized that the pixel defect can be tolerated by the customers after it is repaired.

FIG. 15 is a flow chart of a method for repairing a display defect provided by a third embodiment of the present disclosure. As shown in FIG. 15, the method comprised the following steps.

At step 301, a foreign matter defect in a display panel is detected.

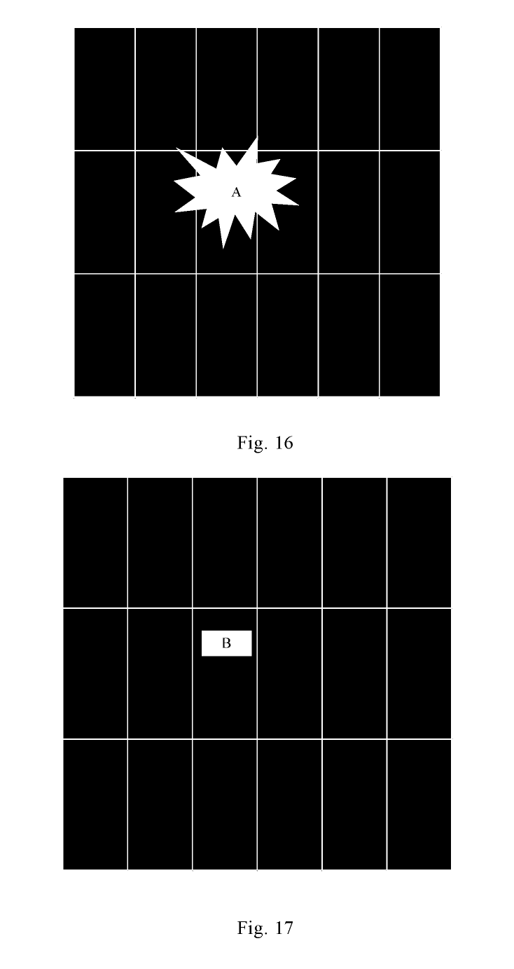

FIG. 16 is a diagram showing a foreign matter defect in the third embodiment. As shown in FIG. 16, it is detected that the display defect is a foreign matter defect by detecting the display panel.

At step 302, a partial structure of the foreign matter defect is repaired, so that the size of the remaining structure of the foreign matter defect is smaller than a test standard value.

FIG. 17 is a diagram showing the remaining structure of a foreign matter defect in the third embodiment. As shown in FIG. 17, the partial structure of the foreign matter defect can be repaired by burning so that the diameter of the remaining structure B of the foreign matter defect is smaller than a test standard value, to satisfy the customer's requirement. The test standard value can be set according to the customers' requirements.

According to the methods for repairing a display defect provided by the present disclosure, the display defect of the display panel is detected to be a foreign matter defect and a partial structure of the foreign matter defect is repaired so that the remaining structure of the foreign matter defect is smaller than a test standard value. Therefore, it can be realized that the foreign matter defect can be tolerated by the customers after it is repaired.

It is to be understood that the above embodiments are merely illustrative embodiments for the purpose of illustrating the principles of the present disclosure, but the present disclosure is not limited thereto. It will be apparent to those skilled in the art that various changes and modifications can be made therein without departing from the spirit and essence of the present disclosure, which are also within the scope of the present disclosure.

1-9. (canceled)

10. A method for repairing a display defect, comprising:
detecting the display defect in a display panel;
repairing a partial structure of the display defect so that a size of a remaining structure of the display defect is smaller than a test standard value.

11. The method for repairing a display defect of claim 10, wherein the step of detecting the display defect in a display panel comprises detecting that the display defect in the display panel is a pixel defect; and
the step of repairing a partial structure of the display defect comprises repairing a partial structure of the pixel defect so that a size of a remaining structure of the pixel defect is smaller than the test standard value.

12. The method for repairing a display defect of claim 11, wherein the pixel defect is a bright spot; and the step of repairing a partial structure of the pixel defect comprises repairing a partial structure of the pixel defect to obtain a partial dark spot, and the remaining structure of the pixel defect is a partial bright spot.

13. The method for repairing a display defect of claim 12, wherein the partial dark spot comprises a ring structure, an inverted L-shaped structure, one or more rectangular structures, or one or more circular structures.

14. The method for repairing a display defect of claim 11, wherein an area of the remaining structure of the pixel defect is within ⅙ to ½ of a total area of the pixel defect.

15. The method for repairing a display defect of claim 14, wherein an area of the remaining structure of the pixel defect is within ⅕ to ⅓ of a total area of the pixel defect.

16. The method for repairing a display defect of claim 10, wherein the step of detecting the display defect in a display panel comprises detecting that the display defect in the display panel is a foreign matter defect; and
the step of repairing a partial structure of the display defect comprises repairing a partial structure of the foreign matter defect so that a size of a remaining structure of the foreign matter defect is smaller than the test standard value.

17. The method for repairing a display defect of claim 10, wherein a diameter of the remaining structure of the display defect is smaller than the test standard value.

18. The method for repairing a display defect of claim 11, wherein a diameter of the remaining structure of the display defect is smaller than the test standard value.

19. The method for repairing a display defect of claim 12, wherein a diameter of the remaining structure of the display defect is smaller than the test standard value.

20. The method for repairing a display defect of claim 13, wherein a diameter of the remaining structure of the display defect is smaller than the test standard value.

21. The method for repairing a display defect of claim 14, wherein a diameter of the remaining structure of the display defect is smaller than the test standard value.

22. The method for repairing a display defect of claim 15, wherein a diameter of the remaining structure of the display defect is smaller than the test standard value.

23. The method for repairing a display defect of claim 16, wherein a diameter of the remaining structure of the display defect is smaller than the test standard value.

24. The method for repairing a display defect of claim 10, wherein the step of repairing a partial structure of the display defect comprises repairing a partial structure of the pixel defect by a laser repairing.

25. The method for repairing a display defect of claim 11, wherein the step of repairing a partial structure of the display defect comprises repairing a partial structure of the pixel defect by a laser repairing.

26. The method for repairing a display defect of claim 12, wherein the step of repairing a partial structure of the display defect comprises repairing a partial structure of the pixel defect by a laser repairing.

27. The method for repairing a display defect of claim 13, wherein the step of repairing a partial structure of the display defect comprises repairing a partial structure of the pixel defect by a laser repairing.

28. The method for repairing a display defect of claim 14, wherein the step of repairing a partial structure of the display defect comprises repairing a partial structure of the pixel defect by a laser repairing.

29. The method for repairing a display defect of claim 15, wherein the step of repairing a partial structure of the display defect comprises repairing a partial structure of the pixel defect by a laser repairing.
